(19) United States
(12) Patent Application Publication
(10) Pub. No.: US 2023/0207912 A1
(43) Pub. Date: Jun. 29, 2023

(54) BATTERY MANAGEMENT SYSTEM

(71) Applicant: YAMAHA HATSUDOKI KABUSHIKI KAISHA, Iwata-shi (JP)

(72) Inventor: Kazuki YAMAMOTO, Shizuoka (JP)

(21) Appl. No.: 18/116,428

(22) Filed: Mar. 2, 2023

Related U.S. Application Data
(63) Continuation of application No. PCT/JP2021/030421, filed on Aug. 19, 2021.

(30) Foreign Application Priority Data
Sep. 3, 2020 (JP) 2020-148412

(51) Int. Cl. H01M 10/48; H01M 10/42; H02J 7/00

(52) U.S. Cl. CPC H01M 10/48; H01M 10/425; H02J 7/005; H02J 7/0048

(57) ABSTRACT

A battery management system for managing information of a battery unit includes a combination of a plurality of battery packs including a plurality of cells. An information processing unit obtains battery pack information representing a status of the plurality of battery packs and obtains battery unit information representing a status of the battery unit based on the obtained battery pack information. A server receives the battery unit information transmitted from the information processing unit. The server transmits at least a portion of the received battery unit information to a user terminal.

### CROSS REFERENCE TO RELATED APPLICATIONS

This application claims the benefit of priority to Japanese Patent Application No. 2020-148412 filed on Sep. 3, 2020 and is a Continuation Application of PCT Application No. PCT/JP2021/030421 filed on Aug. 19, 2021. The entire contents of each application are hereby incorporated herein by reference.

### BACKGROUND OF THE INVENTION

### 1. Field of the Invention

The present invention relates to a battery management system that manages information of a battery unit that includes a combination of a plurality of battery packs.

### 2. Description of the Related Art

Machines that operate on electric power supplied from batteries include, for example, electrically powered vehicles and electrically assisted vehicles. Typically, these vehicles are equipped with a battery, and the electric motor can rotate and the vehicle can run by the power supplied from the battery. Batteries are rechargeable and can be recharged for repeated use.

In recent years, from the viewpoint of environmental protection, it has been proposed to reuse batteries used in such vehicles as described above on other machines. International Publication No. 2012/133212 discloses a system that predicts when and how much reusable batteries will be supplied by obtaining information about vehicles in which batteries are being currently used and information about the on-vehicle batteries. This makes it easier for those who reuse batteries to make battery procurement plans and apparatus manufacturing plans.

Thus, by managing the status of individual batteries on the basis of recycling, it is possible to make easier the reuse of batteries.

### SUMMARY OF THE INVENTION

Information about individual batteries as described above is useful when a battery is reused as a used battery by itself or when a battery is disassembled and recycled as a resource. However, when a battery is reused as a used battery by itself, its use is very limited, for example, to vehicles and apparatuses that are compatible with the output characteristics of the used battery. When disassembling and recycling a battery, it is necessary to disassemble and classify the battery so that it can be reused as a resource, which requires labor and cost for recycling.

Preferred embodiments of the present invention provide battery management systems that each facilitate a wide range of uses of battery packs.

A battery management system according to a preferred embodiment of the present invention is a battery management system that manages information of a battery unit which includes a combination of a plurality of battery packs including a plurality of cells, the battery management system including an information processing unit to obtain battery pack information representing the status of the plurality of battery packs and obtain battery unit information representing the status of the battery unit based on the obtained battery pack information; and a server to receive the battery unit information transmitted from the information processing unit and transmit at least a portion of the received battery unit information to a user terminal.

In a system that uses a battery unit including a combination of a plurality of battery packs, the battery unit information is obtained by the information processing unit and transmitted to the server. Since there is no need to transmit information of each of the plurality of battery packs to the server, it is possible to reduce the amount of data communication between the information processing unit and the server.

The user using the battery unit can properly use the battery unit by referring to the battery unit information transmitted from the server. The user can evaluate the battery unit without having to worry about the status of the individual battery packs, thus improving the usability for the user.

The provider of the battery unit only needs to disclose the specifications of the battery unit to the user, and does not need to disclose the specifications of the individual battery packs to the user. This increases the variety of battery packs to be used and increases the variety of how battery packs can be combined, making it possible to suit a wide range of applications.

In a preferred embodiment of the present invention, the battery pack information may include information regarding at least one of voltage, current, output, temperature, or SOC (State Of Charge) of each of the plurality of battery packs; and the information processing unit may calculate the battery unit information using the battery pack information.

It is possible to calculate the battery unit information from the contents represented by the battery pack information.

In a preferred embodiment of the present invention, the battery unit information may include information regarding at least one of voltage, current, output, temperature, or SOC (State Of Charge) of the battery unit.

The user using the battery unit can evaluate the battery unit using the battery unit information.

In a preferred embodiment of the present invention, the information processing unit may transmit to the server a portion of the battery unit information obtained based on the battery pack information.

By transmitting only a portion of the battery unit information to the server, it is possible to further reduce the amount of data communication between the information processing unit and the server.

In a preferred embodiment of the present invention, the server may transmit a portion of the battery unit information received from the information processing unit to the user terminal.

By transmitting only a portion of the battery unit information to the user terminal, it is possible to reduce the amount of data communication between the server and the user terminal.

In a preferred embodiment of the present invention, if the server receives a request from the user terminal to transmit contents of the battery unit information that has not been transmitted to the user terminal, the server may transmit the requested contents of the battery unit information to the user terminal.

When the user needs information that has not been transmitted to the user terminal, the information can be provided to the user, thus improving the usability for the user.

In a preferred embodiment of the present invention, if the server receives a request from the user terminal to transmit the battery pack information, the server may transmit the request to transmit the battery pack information to the information processing unit; the information processing unit, having received the request from the server, may transmit the battery pack information to the server; and the server may transmit the battery pack information received from the information processing unit to the user terminal.

When the user needs the battery pack information, the battery pack information can be provided to the user, thus improving the usability for the user.

By transmitting the battery pack information only when requested by the user, it is possible to reduce the amount of data communication.

In a system that uses a battery unit including a combination of a plurality of battery packs, the battery unit information is obtained by the information processing unit and transmitted to the server. Since there is no need to transmit information of each of the plurality of battery packs to the server, it is possible to reduce the amount of data communication between the information processing unit and the server.

The user using the battery unit can properly use the battery unit by referring to the battery unit information transmitted from the server. The user can evaluate the battery unit without having to worry about the status of the individual battery packs, thus improving the usability for the user.

The provider of the battery unit only needs to disclose the specifications of the battery unit to the user, and does not need to disclose the specifications of the individual battery packs to the user. This increases the variety of battery packs to be used and increases the variety of how battery packs can be combined, making it possible to suit a wide range of applications.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram showing a battery management system 100 according to a preferred embodiment of the present invention.

FIG. 2 is a perspective view of a battery unit 200 according to a preferred embodiment of the present invention.

FIG. 3 is a diagram showing an example of a battery unit 200 and a battery pack 10 according to a preferred embodiment of the present invention.

FIG. 4 is a flow chart showing an operation of the battery unit 200 according to a preferred embodiment of the present invention.

FIG. 5 is a flow chart showing an operation of a server 300 according to a preferred embodiment of the present invention.

FIG. 6 is a chart showing an example of cell information 101, battery pack information 110, and battery unit information 220 according to a preferred embodiment of the present invention.

FIG. 7 is a flow chart showing another example of an operation of the server 300 according to a preferred embodiment of the present invention.

FIG. 8 is a flow chart showing the process of calculating a second upper limit output of the battery unit 200 according to a preferred embodiment of the present invention.

FIG. 9 is a chart showing an example of calculation of the second upper limit output of the battery unit 200 according to a preferred embodiment of the present invention.

FIG. 10 is a chart showing another example of calculation of the second upper limit output of the battery unit 200 according to a preferred embodiment of the present invention.

FIG. 11 is a diagram showing a plurality of groups obtained from a plurality of battery packs 10 according to a preferred embodiment of the present invention.

### DETAILED DESCRIPTION OF THE PREFERRED EMBODIMENTS

Battery management systems according to preferred embodiments of the present invention will be described below with reference to the drawings. In the description below, like components will be denoted by like reference signs, and their descriptions will be omitted where redundant. The following preferred embodiments are examples, and the present preferred embodiment is not limited to the following preferred embodiments.

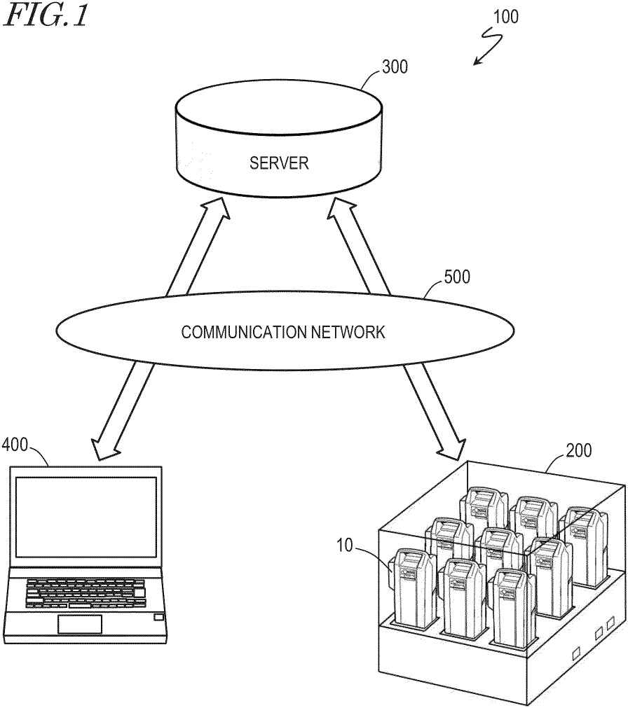

FIG. 1 is a diagram showing a battery management system 100 according to a preferred embodiment of the present invention. The battery management system 100 manages information on a battery unit 200 that includes a combination of a plurality of battery packs 10. With the battery management system 100, the battery unit 200 transmits and receives information to and from a server 300 via a communication network 500. For example, the battery unit 200 transmits battery unit information indicating the status of the battery unit 200 to the server 300. The communication network 500 is, for example, but not limited to, the Internet.

The server 300 receives the battery unit information transmitted from battery unit 200. The server 300 transmits and receives information to and from a terminal device 400 of the user using the battery unit 200 via the communication network 500. For example, the server 300 transmits at least a portion of the received battery unit information to the user terminal device 400.

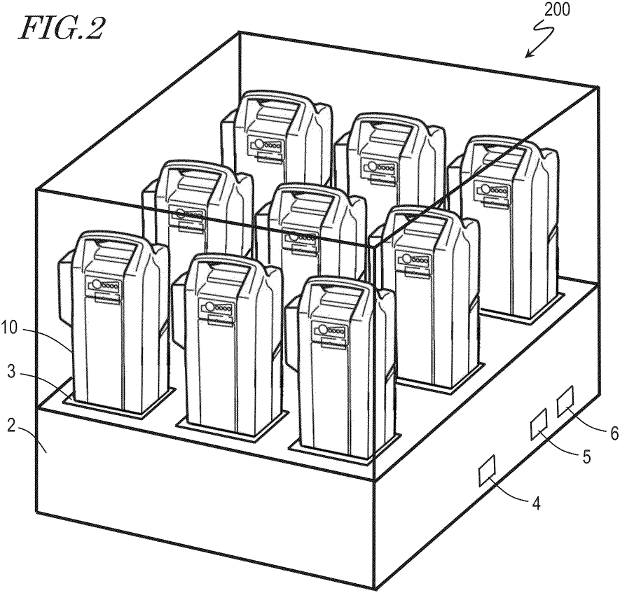

FIG. 2 is a perspective view showing the battery unit 200. The battery unit 200 includes a combination of a plurality of battery packs 10 for charging and discharging. The battery unit 200 is used, for example, as a stationary energy storage system. The stationary energy storage system can be used, for example, in power generation facilities that use renewable energy, such as solar power generation facilities and wind power generation facilities. The stationary energy storage system can also be used as an emergency power source in the event of a disaster or the like.

The battery unit 200 includes a housing 2 and a plurality of connectors (connecting devices) 3 provided on the housing 2. The number of connectors 3 can be any number of two or more. A battery pack 10 is connected to each of the plurality of connectors 3. The battery unit 200 discharges a group including one or more of the plurality of battery packs 10 as a unit.

The housing 2 of the battery unit 200 includes a charging connector 4 and discharging connectors 5 and 6. The charging connector 4 is connected to a power generator such as, for example, a solar power generator and a wind power generator, and the battery packs 10 can be charged by the power generated by the power generator. For example, the battery packs 10 may be charged by connecting the charging connector 4 to any power source, such as a household power source.

The discharging connectors 5 and 6 are connected to loads (external devices), for example. The power output from the battery packs 10 is output from the discharging connectors 5 and 6. The discharging connector 5 outputs direct current power. The discharging connector 6 outputs alternating current power. Depending on the application of the battery unit 200, the battery unit 200 may include only one of the discharging connectors 5 and 6.

Each of the battery packs 10 can be attached to and detached from the battery unit 200. The battery packs 10 are, for example, used battery packs that have been installed and used in machines such as electrically powered vehicles and electrically assisted vehicles. Battery packs 10 are removed from those machines and attached to the battery unit 200 for reuse. Note that the battery packs 10 installed in the battery unit 200 are not limited to used battery packs, but can also be new battery packs. A mixture of used battery packs and new battery packs may also be used. Battery packs 10 used in the battery unit 200 may be replaced with other battery packs 10 depending on their conditions. For example, a battery pack 10 that has deteriorated is removed from the battery unit 200 and replaced with another battery pack 10.

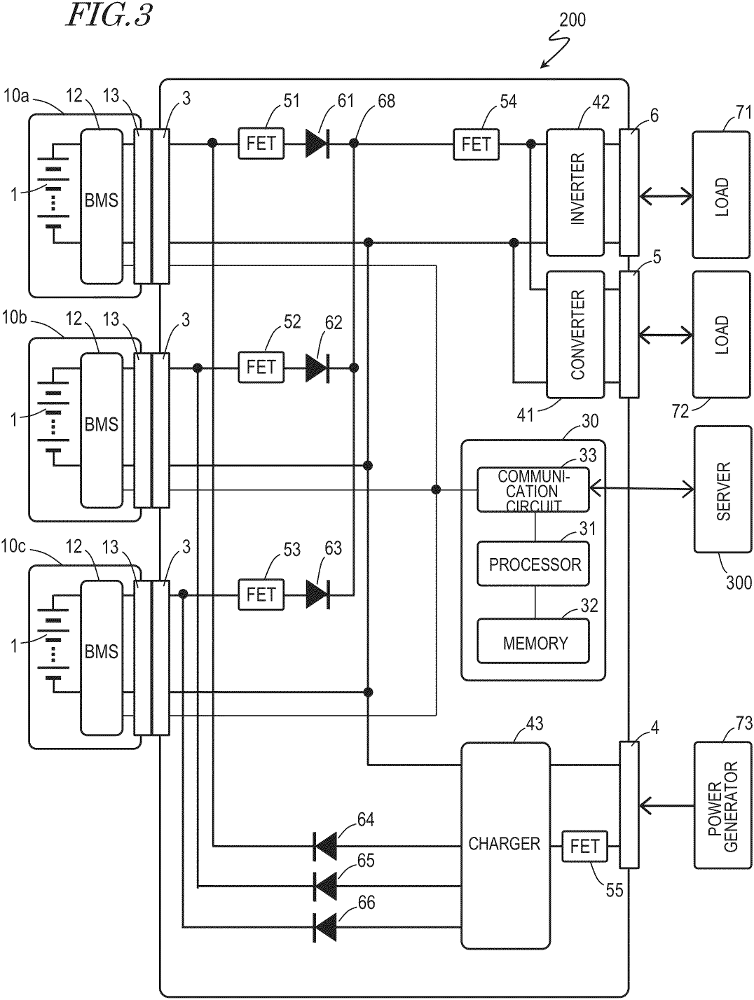

FIG. 3 is a diagram showing an example of the battery unit 200 and the battery packs 10.

In order to describe a preferred embodiment of the present invention in an easy-to-understand manner, the following description will focus primarily on a preferred embodiment where the battery unit 200 includes three battery packs 10, but the present invention is not limited thereto. The number of battery packs 10 installed in the battery unit 200 is arbitrary and can be two, four or more, and the present invention is applicable to those preferred embodiments as well. In the example shown in FIG. 3, three battery packs 10a, 10b, 10c are installed as battery packs 10 in the battery unit 200.

A battery pack 10 includes a plurality of cells 1, a battery management system (BMS) 12, and a connector 13. The BMS 12 controls various operations of the battery pack 10, such as charging and discharging, and monitors various states of the battery pack 10. The BMS 12 monitors the voltage, current, temperature, SOC (State of Charge), SOH (State of Health), etc., of the battery pack 10. The connector 13 of battery pack 10 is connected to the connector 3 of the battery unit 200. The current output from the plurality of cells 1 is supplied into the battery unit 200 via the BMS 12 and the connector 13.

In the battery unit 200, a plurality of battery packs 10a, 10b, 10c are connected in parallel with each other. The battery pack 10a is connected to a converter 41 and an inverter 42 via a PWM (Pulse Width Modulation) switching element 51, a diode 61 and a discharging switching element 54. The battery pack 10b is connected to the converter 41 and the inverter 42 via a PWM switching element 52, a diode 62, and a discharging switching element 54. The battery pack 10c is connected to the converter 41 and the inverter 42 via a PWM switching element 53, a diode 63, and a discharging switching element 54.

When a load (external device) 71 is connected to the discharging connector 6, the inverter 42 converts the input direct current voltage to an alternating current voltage, and outputs it to the load 71. When a load 71 is connected to the discharging connector 5, the converter 41 adjusts the magnitude of the input direct current voltage, and outputs it to the load 71. Depending on the application of the battery unit 200, the battery unit 200 may include only one of the converter 41 and the inverter 42.

When the power generator 73 is connected to the charging connector 4, the electric power output from the power generator 73 is input to the charger 43 via the charging connector 4 and the charging switching element 55. The charger 43 adjusts the magnitude of the voltage and the current, and outputs it to the battery pack 10. When charging the battery pack 10a, the current output from the charger 43 is supplied to the battery pack 10a via the diode 64 and the connector 3. When charging the battery pack 10b, the current output from the charger 43 is supplied to the battery pack 10b via the diode 65 and the connector 3. When charging the battery pack 10c, the current output from the charger 43 is supplied to a battery pack 10c via the diode 66 and the connector 3.

The switching elements 51, 52, 53, 54, 55 are, for example, field effect transistors (FETs), but they are not limited to field effect transistors, and any switching elements may be used.

An information processing unit 30 is a controller that controls the operation of the battery unit 200. The information processing unit 30 includes a processor 31, a memory 32, and a communication circuit 33. The processor 31 is a signal processing circuit (computer) that controls the operation of the battery unit 200. Typically, the processor 31 is a semiconductor integrated circuit.

The memory 32 stores a computer program that causes the processor 31 to control the operation of the battery unit 200. Such a computer program may be installed in the battery unit 200 from a recording medium (a semiconductor memory, an optical disk, etc.) on which it is recorded, or may be downloaded via a telecommunication line such as the Internet. Such a computer program may be installed in the battery unit 200 via wireless communication. Such a computer program may be sold as packaged software. The processor 31 executes the computer program stored in the memory 32 to control the operation of the battery unit 200.

The processor 31 communicates with the BMS 12 of the battery pack 10 via the communication circuit 33. The processor 31 communicates with the server 300 via the communication circuit 33. The processor 31 transmits and receives necessary information to and from the BMS 12 when charging and discharging the battery pack 10. The processor 31 also receives battery pack information, such as voltage, current, and temperature of the battery pack 10, from the BMS 12.

The processor 31 controls the operation of the converter 41, the inverter 42, the charger 43, and the switching elements 51, 52, 53, 54, 55. During the discharge operation of the battery unit 200, the processor 31 turns on the switching element 54. The processor 31 performs PWM control by repeatedly switching ON/OFF the switching elements 51, 52, 53. The direct current voltage modulated by PWM control is input to the converter 41 or the inverter 42. During the charge operation of the battery pack 10, the processor 31 turns on the switching element 55 and controls the operation of the charger 43 to supply electric power to the battery pack 10 to be charged.

When charging, one of the switching elements 51, 52, 53 that corresponds to the battery pack 10 to be charged may be turned off. For example, assume that the voltage of the battery pack 10c is the lowest among the battery packs 10a, 10b, 10c, and that the battery pack 10c is to be charged. When charging the battery pack 10c, it is possible to prevent the current for charging from flowing to the discharge side of the circuit by turning off the switching element 53. This allows the battery pack 10c to be charged while discharging the battery packs 10a and 10b. Thus, with the battery unit 200, charging and discharging can be done in parallel. The gap between the voltage of the battery pack 10c to be charged and the voltage of the battery packs 10a and 10b to be discharged can be resolved, and after the battery pack 10c is charged to the desired level, the battery pack 10c can be discharged together with the battery packs 10a and 10b.

When charging, one of the switching elements 51, 52, 53 corresponding to the battery pack 10 to be charged may be turned on. For example, when charging the battery pack 10c, the switching element 53 is turned on. In this case, part of the current for charging flows to the discharge side of the circuit. In other words, part of the electric power output from the charger 43 is used as electric power for discharge. Since the current output from the battery pack 10c to be charged decreases, the gap between the voltage of the battery pack 10c and the voltage of the battery packs 10a and 10b can be reduced.

Next, the operation of the battery management system 100 managing battery unit information will be described in more detail.

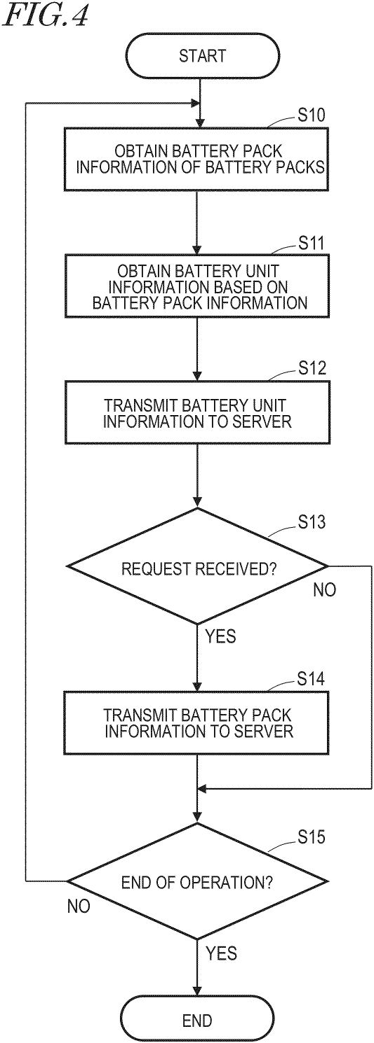

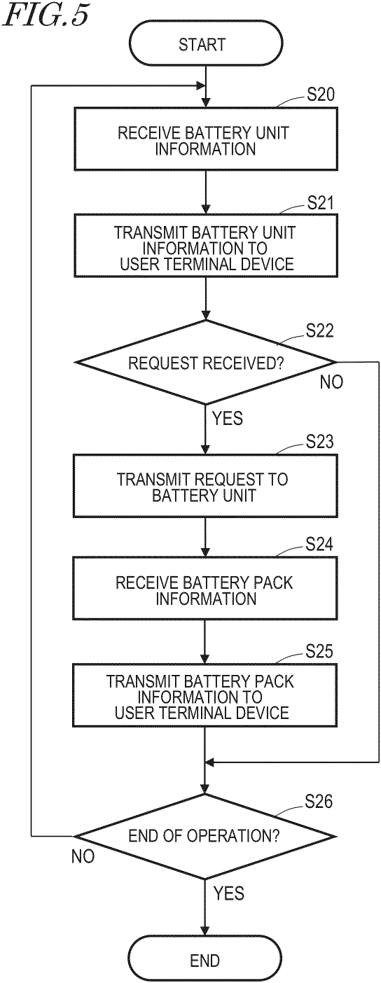

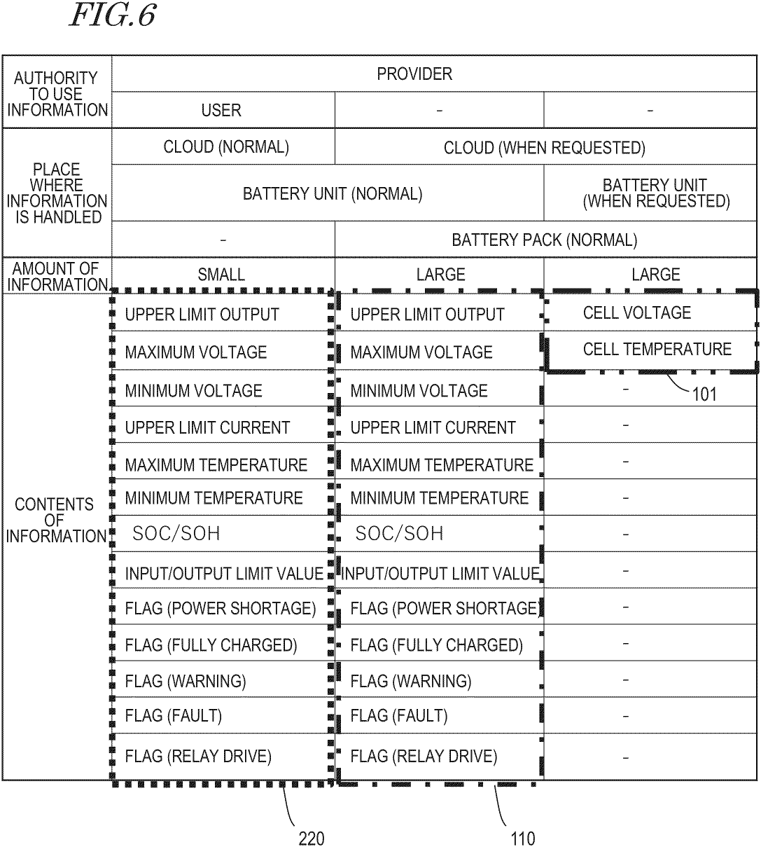

FIG. 4 is a flow chart showing an operation of the battery unit 200. FIG. 5 is a flow chart showing the operation of the server 300. FIG. 6 is a chart showing an example of cell information 101, battery pack information 110, and battery unit information 220. The information encircled by a two-dot-chain line in FIG. 6 is the cell information 101. The information encircled by a one-dot-chain line is the battery pack information 110. The information encircled by a dotted line is the battery unit information 220.

The BMS 12 (FIG. 3) of the battery pack 10 detects the cell voltage, which is the voltage of each of the plurality of cells 1. It also detects the cell temperature, which is the temperature at multiple locations in the collection of cells 1. The cell information 101 includes these detected values.

The BMS 12 generates the battery pack information 110 using the cell information 101, etc. The battery pack information 110 is information that indicates the status of each of the plurality of battery packs 10. The battery pack information 110 includes information regarding voltage, current, output, temperature, SOC, SOH, etc., of each of the plurality of battery packs 10.

The upper limit output of the battery pack 10 is the upper limit value of electric power that the battery pack 10 can output. The upper limit output varies depending on the current state of the battery pack 10. For example, the upper limit output varies depending on SOC, temperature, etc. In the following description, the upper limit output of the battery pack 10 is referred to as the “first upper limit output”.

The BMS 12 detects the voltage of the battery pack 10. The BMS 12 obtains the upper limit current of battery pack 10 corresponding to the detected value of voltage. The upper limit current is the upper limit value of current that the battery pack 10 can output when the voltage of the battery pack 10 is of the detected magnitude. For example, the BMS 12 stores in advance a map showing the relationship between the voltage and the upper limit current. The BMS 12 can use such a map to obtain the upper limit current from the detected value of voltage. The BMS 12 obtains the first upper limit output of the battery pack 10 by multiplying the detected value of voltage by the upper limit current value.

The maximum voltage and the minimum voltage of the battery pack 10 represent the maximum value and the minimum value of the voltage of the plurality of cells 1 included in the battery pack 10. The maximum temperature and the minimum temperature of the battery pack 10 represent the maximum value and the minimum value of the temperatures at a plurality of locations in the collection of cells 1.

The BMS 12 outputs the battery pack information 110 including those information to the processor 31 (FIG. 3), and the processor 31 obtains the battery pack information 110 (step S10 in FIG. 4). Note that the processor 31 may obtain the first upper limit output by multiplying the detected value of voltage by the upper limit current value.

The processor 31 obtains the battery unit information 220 based on the battery pack information 110 (step S11). The battery unit information 220 is information that indicates the status of the battery unit 200. The battery unit information 220 includes information regarding voltage, current, output, temperature, SOC, SOH, etc., of the battery unit 200.

The upper limit output of the battery unit 200 is the upper limit value of electric power that the battery unit 200 can output. In the following description, the upper limit output of the battery unit 200 is referred to as the “second upper limit output”. The processor 31 calculates the second upper limit output of the battery unit 200 using, for example, the first upper limit output of each of the battery packs 10.

The maximum voltage and the minimum voltage of the battery unit 200 represent the maximum value and the minimum value of the voltages of the plurality of battery packs 10 included in the battery unit 200. The maximum temperature and the minimum temperature of the battery unit 200 represent the maximum value and the minimum value of the temperatures of the plurality of battery packs 10 included in battery unit 200.

The processor 31 transmits the battery unit information 220 to the server 300 using the communication circuit 33 (FIG. 3) (step S12). Referring to FIG. 1 and FIG. 5, the server 300 receives the battery unit information 220 from the battery unit 200 via the communication network 500 (step S20) .

The server 300 includes, for example, a processor, a storage device, a communication circuit, etc., not shown. The server 300 stores the received battery unit information 220 in the storage device. The server 300 also transmits the battery unit information 220 to the terminal device 400 of the user using the battery unit 200 (step S21). The user terminal device 400 receives the battery unit information 220 from the server 300 via the communication network 500. The user can configure the charging and discharging of the battery unit 200 by using the received battery unit information 220.

With the battery management system 100 of the present preferred embodiment, the battery unit information 220 is obtained by the information processing unit 30 (FIG. 3) of the battery unit 200 and the obtained battery unit information 220 is transmitted to the server 300. Since there is no need to transmit the battery pack information 110 of each of the plurality of battery packs 10 to the server 300, it is possible to reduce the amount of data communication between the information processing unit 30 and the server 300.

For example, if the battery unit 200 includes 24 battery packs 10, the amount of data communication becomes large if the battery pack information 110 for the 24 battery packs (FIG. 6) are transmitted to the server 300. In the present preferred embodiment, the battery unit information 220 generated by aggregating the battery pack information 110 for the 24 battery packs is transmitted to the server 300. In this case, the amount of data communication can be reduced to approximately 1/24. Note that the number of battery packs 10 (24) is an example, and the number of battery packs 10 is not limited thereto.

The user using the battery unit 200 can properly use the battery unit 200 by referring to the battery unit information 220 transmitted from the server 300. The user does not need to worry about how to operate the battery unit 200 while looking at the numerous battery pack information 110. The user can evaluate the battery unit 200 without having to worry about the status of individual battery packs 10, thus improving the convenience for the user side.

The provider of the battery unit 200 only needs to disclose the specifications of the battery unit 200 to the user, and does not need to disclose the specifications of the individual battery packs 10 to the user. This increases the variety of battery packs 10 to be used and increases the variety of how battery packs 10 are combined, making it possible to suit a wide range of applications.

When the user needs the battery pack information 110, the battery pack information 110 is provided to the user. Referring to FIG. 5, the server 300 determines whether a request to transmit the battery pack information 110 has been received from the user terminal device 400 (step S22). If it is determined that the request has been received from the user terminal device 400, the server 300 transmits a request for transmission of the battery pack information 110 to the battery unit 200 (step S23).

Referring to FIG. 4, the processor 31 of the battery unit 200 determines whether a request for transmission of the battery pack information 110 has been received from the server 300 (step S13). If it is determined that the request has been received from the server 300, the processor 31 transmits the battery pack information 110 to the server 300 (step S14).

Referring to FIG. 5, the server 300 receives the battery pack information 110 transmitted from the battery unit 200 (step S24). The server 300 transmits the received battery pack information 110 to the user terminal device 400 (step S25).

In order to stop the operation of the battery unit 200, the transmission and reception of information is terminated (step S15, S26).

When the user of the battery unit 200 needs the battery pack information 110, the battery pack information 110 can be provided to the user, thus improving the usability for the user. By transmitting the battery pack information 110 only when requested by the user, it is possible to reduce the amount of data communication.

Note that the server 300 may transmit only a portion of the battery unit information 220 to the user terminal device 400. Then, it is possible to reduce the amount of data communication between the server 300 and the user terminal device 400.

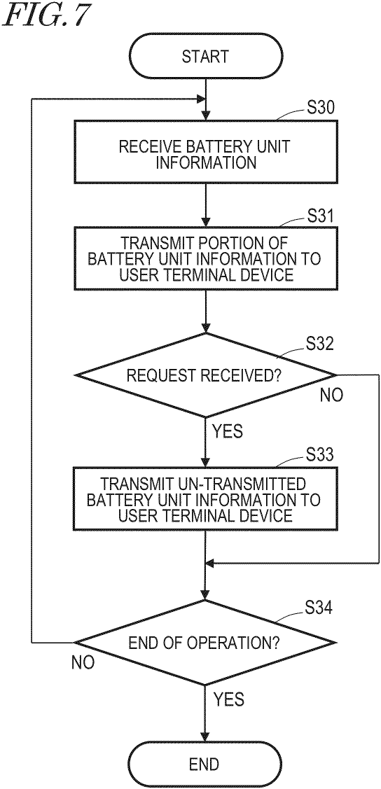

FIG. 7 is a flow chart showing another example of the operation of the server 300.

Referring to FIG. 4 and FIG. 7, the processor 31 of the battery unit 200 transmits the battery unit information 220 to the server 300 (step S12). The server 300 receives the battery unit information 220 from the battery unit 200 (step S30). The server 300 transmits a portion of the received battery unit information 220 to the user terminal device 400 (step S31). Thus, by transmitting only a portion of the battery unit information 220 to the user terminal device 400, it is possible to reduce the amount of data communication between the server 300 and the user terminal device 400.

The server 300 determines whether a request for transmission has been received from the user terminal device 400 regarding the contents of the battery unit information 220 has not been transmitted to the user terminal device 400 (step S32). If it is determined that a request has been received, the server 300 transmits the contents of the requested battery unit information 220 to the user terminal device 400 (step S33). Thus, when the user needs information that has not been transmitted to the user terminal device 400, the information can be provided to the user, thus improving the usability for the user. In order to stop the operation of the battery unit 200, the transmission and reception of information is terminated (step S34).

The information processing unit 30 of the battery unit 200 may transmit a portion of the battery unit information 220 to the server 300. By transmitting only a portion of the battery unit information 220 to the server 300, it is possible to further reduce the amount of data communication between the battery unit 200 and the server 300. In this case, if the server 300 receives a request for transmission from the user terminal device 400 regarding the contents of the battery unit information 220 that has not been transmitted to the user terminal device 400, the information processing unit 30 may transmit the requested contents of the battery unit information 220 to the server 300. The server 300 transmits the contents of the received battery unit information 220 to the user terminal device 400. When the user needs information that has not been transmitted to the user terminal device 400, the information may be provided to the user, thus improving the usability for the user.

Next, an example of a method for calculating the upper limit output of the battery unit 200 according to the present preferred embodiment will be described.

The processor 31 controls the discharge of a plurality of battery packs 10. The processor 31 calculates the second upper limit output of the battery unit 200 when discharging one or more battery packs 10. As described above, the second upper limit output is the upper limit value of electric power that the battery unit 200 can output.

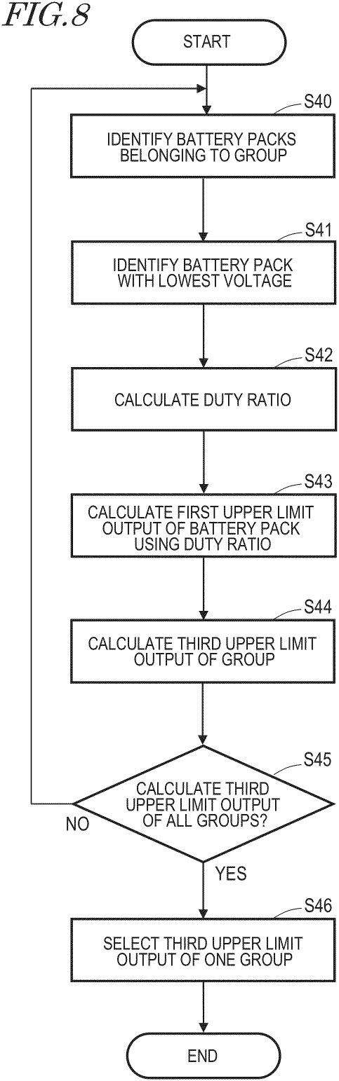

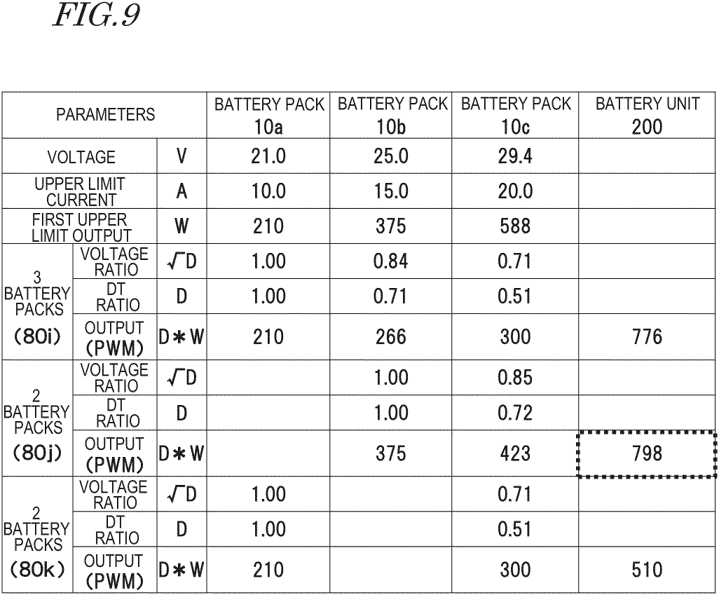

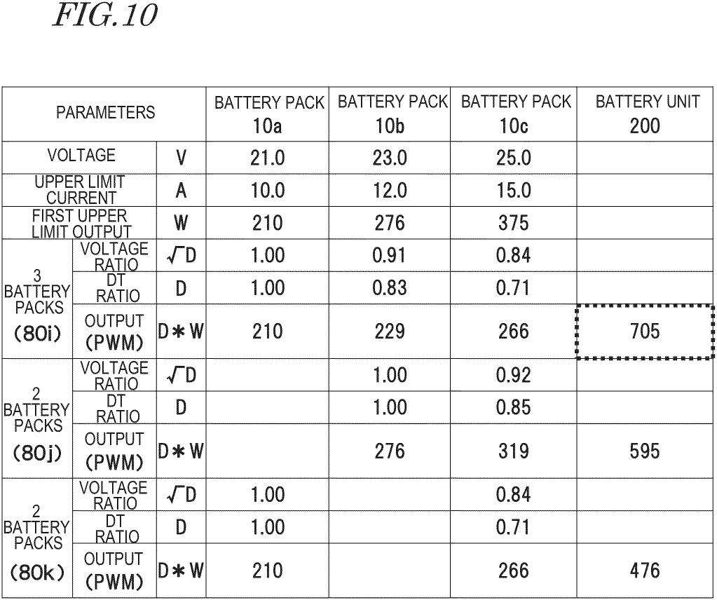

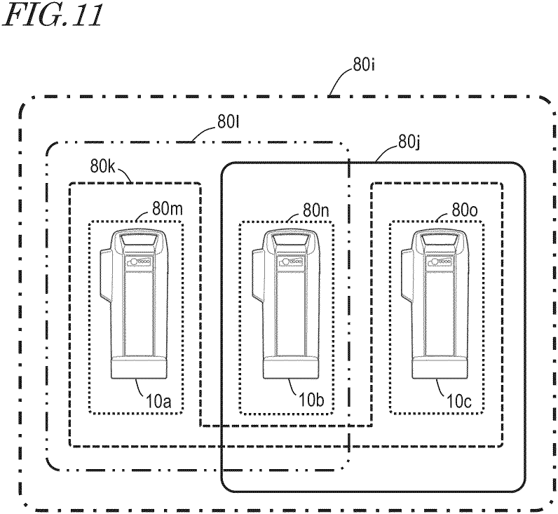

FIG. 8 is a flow chart showing the process of calculating the second upper limit output of the battery unit 200. FIG. 9 is a chart showing an example of calculation of the second upper limit output of the battery unit 200. FIG. 10 is a chart showing another example of calculation of the second upper limit output of the battery unit 200. FIG. 11 is a diagram showing a plurality of groups including one or more of the plurality of battery packs 10.

Referring to FIG. 11, when the number of battery packs 10 is 3, the number of groups containing one or more of the battery packs 10 is 7. FIG. 11 shows those 7 groups 80i, 80j, 80k, 80l, 80m, 80n, 80o. The processor 31 calculates the upper limit output for each of the plurality of groups 80i, 80j, 80k, 80l, 80m, 80n, 80o. The upper limit output of a group is the upper limit value of electric power that the group can output. In the following description, the upper limit output of the group will be referred to as the “third upper limit output”.

The processor 31 receives the detected voltage value and the upper limit current value from the BMS 12 of each battery pack 10. FIG. 9 shows an example of the voltage and upper limit current for the battery packs 10a, 10b, 10c. The first upper limit output of each battery pack 10 is obtained by multiplying the voltage by the upper limit current.

Referring to FIG. 8, the processor 31 identifies a battery pack 10 belonging to one of the plurality of groups (step S40). For example, the battery packs belonging to the group 80i are identified as battery packs 10a, 10b, 10c.

The processor 31 identifies the battery pack with the lowest voltage among the battery packs 10a, 10b, 10c belonging to the group 80i (step S41). In the example shown in FIG. 9, the battery pack 10a is identified as the battery pack with the lowest voltage. The processor 31 sets the voltage, 21.0 (V), of the battery pack 10a with the lowest voltage as the reference voltage.

The processor 31 calculates the ratio between the voltage of each of the other battery packs 10b, 10c belonging to the group 80i and the reference voltage. In the example shown in FIG. 9, the voltage ratio of the battery pack 10b is 0.84 and the voltage ratio of the battery pack 10c is 0.71.

The processor 31 calculates the duty ratio (DT ratio) to be applied to PWM control of each of the battery packs 10a, 10b, 10c (step S42). The duty ratio is obtained by squaring the voltage ratio.

The processor 31 calculates the first upper limit output of each of the battery packs 10a, 10b, 10c with the calculated duty ratio applied (step S43). In the example shown in FIG. 9, the first upper limit output of the battery pack 10a is 210 (W), the first upper limit output of the battery pack 10b is 266 (W), and the first upper limit output of the battery pack 10c is 300 (W).

The processor 31 adds together the first upper limit outputs with these duty ratios applied to obtain the third upper limit output for the group (step S44). In the example shown in FIG. 9, 776 (W) is obtained as the third upper limit output for the group 80i.

In step S45, the processor 31 determines whether the third upper limit outputs of all groups have been calculated. If the calculation of the third upper limit outputs for all groups has not been completed, the process returns to step S40 and the process is performed for the groups for which calculation has not yet been performed.

In the example shown in FIG. 9, the processor 31 identifies the battery pack 10b with the lowest voltage from the battery packs 10b, 10c belonging to the group 80j. The processor 31 sets the voltage, 25.0 (V), of the battery pack 10b with the lowest voltage as the reference voltage. Then, the same process as described above is performed to obtain 798 (W) as the third upper limit output of the group 80j.

The processor 31 identifies the battery pack 10a with the lowest voltage from among the battery packs 10a, 10c belonging to the group 80k. The processor 31 sets the voltage, 21.0 (V), of the battery pack 10a with the lowest voltage as the reference voltage. Then, the same process as described above is performed to obtain 510 (W) as the third upper limit output of the group 80k. Similarly, the processor 31 calculates the third upper limit output of the group 801. In FIG. 9, an example of calculation of the third upper limit output of the group 801 is omitted. If there is one battery pack 10 belonging to a group, such as groups 80m, 80n, 80o shown in FIG. 11, the third upper limit output for that group is the first upper limit output for the battery pack 10 belonging to that group.

When the calculation of the third upper limit output for all groups is completed, the process proceeds to step S46 (FIG. 8). In step S46, the processor 31 selects the third upper limit output that is the largest among the third upper limit outputs of all groups. The processor 31 sets the selected third upper limit output as the second upper limit output of the battery unit 200. In the example shown in FIG. 9, the third upper limit output, 798 (W), of the group 80j is the maximum value. The processor 31 sets 798 (W) as the second upper limit output of the battery unit 200.

FIG. 10 shows another example of calculation of the second upper limit output of the battery unit 200. The state of the battery packs 10a, 10b, 10c shown in FIG. 10 is different from FIG. 9. The same process as above is performed for the battery packs 10a, 10b, 10c in the state shown in FIG. 10. The processor 31 selects the third upper limit output that is the largest among the third upper limit outputs of all groups. In the example shown in FIG. 10, the third upper limit output, 705 (W), of the group 80i is the maximum value. The processor 31 sets 705 (W) as the second upper limit output of the battery unit 200.

The processor 31 transmits the battery unit information 220 including the calculated second upper limit output to the server 300 (step S12 in FIG. 4). The value of the second upper limit output to be transmitted to the server 300 may be smaller than the calculated value of the second upper limit output. By presenting a second upper limit output value that is smaller than the calculated value to the user, it is possible to allow the battery unit 200 to perform a discharge operation with margin.

If the second upper limit output of the battery unit 200 is set based on the third upper limit output, 798 (W), of the group 80j shown in FIG. 9, the processor 31 discharges the battery packs 10b and 10c belonging to the group 80j.

The processor 31 sets the voltage, 25.0 (V), of the battery pack 10b which has the lowest voltage among the battery packs 10b and 10c as the reference voltage. The processor 31 adjusts the voltage, 29.4 (V), output from the other battery pack 10c to the reference voltage 25.0 (V) through PWM control. By adjusting the voltages output from the battery packs 10b and 10c belonging to the group 80j selected for discharge so as to be of the same magnitude, the battery packs 10b and 10c belonging to the group 80j can be connected in parallel and discharged.

If the second upper limit output of the battery unit 200 is set based on the third upper limit output, 705 (W), of the group 80i shown in FIG. 10, the processor 31 discharges the battery packs 10a, 10b, 10c belonging to the group 80i.

The processor 31 sets the voltage, 21.0 (V), of the battery pack 10a with the lowest voltage among the battery packs 10a, 10b, 10c as the reference voltage. The processor 31 adjusts the voltage output from the other battery packs 10b, 10c to the reference voltage 21.0 (V) through PWM control. By adjusting the voltages output from the battery packs 10a, 10b, 10c belonging to the group 80i selected for discharge so as to be of the same magnitude, the battery packs 10a, 10b, 10c belonging to the group 80i can be connected in parallel and discharged.

As described above, the battery unit 200 of the present preferred embodiment calculates the second upper limit output of the battery unit 200 using the first upper limit output of the plurality of battery packs 10, and controls the discharge of the plurality of battery packs 10 based on the calculated second upper limit output of the battery unit 200.

In the present preferred embodiment, at least one of the plurality of battery packs 10 installed in the battery unit 200 may have different specifications from other battery packs 10. The specifications may differ from each other among the plurality of battery packs 10.

Regardless of whether the specifications of the plurality of battery packs 10 are the same as or different from each other, the upper limit output is obtainable for each battery pack 10 and the plurality of battery packs 10 are combined based on this upper limit output. Even if the specifications differ from each other among the plurality of battery packs 10, the upper limit output is a common physical quantity among those battery packs 10. Therefore, by evaluating each battery pack 10 using the upper limit output, the battery packs 10 can be combined even if the specifications differ among the battery packs 10. Thus, it is possible to improve the degree of freedom in selecting the battery pack 10.

Depending on the state of the plurality of battery packs 10, it may not be the case that the third upper limit output increases as more battery packs 10 are combined. For example, in the state of the battery packs 10a, 10b, 10c shown in FIG. 9, the third upper limit output is largest when two battery packs 10b and 10c are combined. The third upper limit output is calculated for each of a plurality of groups that differ from each other in the way battery packs 10 are combined, and the third upper limit output that is the largest among the groups is set as the second upper limit output of the battery unit 200. By employing the largest third upper limit output obtained from the combination of the plurality of battery packs 10, it is possible to realize the discharge by making most of the capacity of the plurality of battery packs 10.

As described with reference to FIG. 3, the plurality of battery packs 10 are connected to the converter 41 and the inverter 42 via the diodes 61, 62, 63. The battery packs 10 included in the group selected for discharge are discharged while being connected in parallel with each other. For example, when the group 80j is selected, the battery packs 10b and 10c are discharged while being connected in parallel with each other. At this time, the positive terminal of the battery pack 10a, not included in the group 80j, is connected to a node 68 connected in parallel via the diode 61. The switching element 51 is left on. Since the voltage of the battery pack 10a is lower than the reference voltage of the group 80j, no current flows from battery pack 10a.

If the power consumption of the load 71 increases rapidly during discharge, the output voltage of the battery unit 200 can drop rapidly. When the voltage of the node 68 becomes lower than the voltage of the battery pack 10a, current flows through the diode 61 and the electric power is supplied to the load 71 from the battery pack 10a. Thus, by connecting the unselected battery packs 10 to the node 68 connected in parallel via the diode, it is possible to prevent the battery unit 200 from going down even when the power consumption of the load 71 increases rapidly.

In the description above, the voltage of the battery pack 10 with the lowest voltage among the battery packs 10 included in the group is set as the reference voltage, but the present invention is not limited thereto. The voltages of the battery packs 10 other than the battery pack 10 with the lowest voltage may be set to the reference voltage. In this case, battery packs 10 whose voltages are lower than the reference voltage may be adjusted, by boosting the voltages thereof, so that the voltages output from the battery packs 10 included in the same group are of the same magnitude as each other.

Illustrative preferred embodiments of the present invention have been described.

The battery management system 100 according to a preferred embodiment of the present invention manages information of the battery unit 200 which includes a combination of a plurality of battery packs 10 including a plurality of cells 1. The battery management system 100 includes the information processing unit 30 that obtains the battery pack information 110 representing the status of the plurality of battery packs 10 and obtains the battery unit information 220 representing the status of the battery unit 200 based on the obtained battery pack information 110; and the server 300 that receives the battery unit information 220 transmitted from the information processing unit 30 and transmits at least a portion of the received battery unit information 220 to the user terminal device 400 of the user using the battery unit 200.

In a system using the battery unit 200 including a combination of a plurality of battery packs 10, the battery unit information 220 is obtained by the information processing unit 30 and transmitted to the server 300. Since there is no need to transmit information of each of the plurality of battery packs 10 to the server 300, it is possible to reduce the amount of data communication between the information processing unit 30 and the server 300.

The user using the battery unit 200 can properly use the battery unit 200 by referring to the battery unit information 220 transmitted from the server 300. The user can evaluate the battery unit 200 without having to worry about the status of the individual battery packs 10, thus improving the usability for the user.

The provider of the battery unit 200 only needs to disclose the specifications of the battery unit 200 to the user, and does not need to disclose the specifications of the individual battery packs 10 to the user. This increases the variety of battery packs 10 to be used and increases the variety of how battery packs 10 can be combined, making it possible to suit a wide range of applications.

In a preferred embodiment, the battery pack information 110 may include information regarding at least one of voltage, current, output, temperature and SOC of each of the plurality of battery packs 10; and the information processing unit 30 may calculate the battery unit information 220 using the battery pack information 110. It is possible to calculate the battery unit information 220 from the contents represented by the battery pack information 110.

In a preferred embodiment of the present invention, the battery unit information 220 may include information regarding at least one of voltage, current, output, temperature, and SOC of the battery unit 200.

The user using the battery unit 200 can evaluate the battery unit 200 using the battery unit information 220.

In a preferred embodiment of the present invention, the information processing unit 30 may transmit a portion of the battery unit information 220 obtained based on the battery pack information 110 to the server 300.

By transmitting only a portion of the battery unit information 220 to the server 300, it is possible to further reduce the amount of data communication between the information processing unit 30 and the server 300.

In a preferred embodiment of the present invention, the server 300 may transmit a portion of the battery unit information 220 received from the information processing unit 30 to the user terminal device 400.

By transmitting only a portion of the battery unit information 220 to the user terminal device 400, it is possible to reduce the amount of data communication between the server 300 and the user terminal device 400.

In a preferred embodiment of the present invention, if the server 300 receives a request for transmission from the user terminal device 400 regarding contents of the battery unit information 220 that has not been transmitted to the user terminal device 400, the server 300 may transmit the requested contents of the battery unit information 220 to the user terminal device 400.

When the user needs information that has not been transmitted to the user terminal device 400, the information can be provided to the user, thus improving the usability for the user.

In a preferred embodiment of the present invention, if the server 300 receives a request for transmission of the battery pack information 110 from the user terminal device 400, the server 300 may transmit the request for transmission of the battery pack information 110 to the information processing unit 30; the information processing unit 30, having received the request from the server 300, may transmit the battery pack information 110 to the server 300; and the server 300 may transmit the battery pack information 110 received from the information processing unit 30 to the user terminal device 400.

When the user needs the battery pack information 110, the battery pack information 110 can be provided to the user, thus improving the usability for the user. By transmitting the battery pack information 110 only when requested by the user, it is possible to reduce the amount of data communication.

The present invention is particularly useful in technical fields in which a plurality of battery packs are used in combination.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A battery management system for managing information of a battery unit that includes a combination of a plurality of battery packs including a plurality of cells, the battery management system comprising:
an information processing unit to obtain battery pack information representing a status of the plurality of battery packs and obtain battery unit information representing a status of the battery unit based on the obtained battery pack information; and
a server to receive the battery unit information transmitted from the information processing unit and transmit at least a portion of the received battery unit information to a user terminal.

2. The battery management system according to claim 1, wherein
the battery pack information includes information regarding at least one of voltage, current, output, temperature, or state of charge of each of the plurality of battery packs; and
the information processing unit is operable to calculate the battery unit information using the battery pack information.

3. The battery management system according to claim 1, wherein the battery unit information includes information regarding at least one of voltage, current, output, temperature, or state of charge of the battery unit.

4. The battery management system according to claim 1, wherein the information processing unit is operable to transmit to the server only a portion of the battery unit information obtained based on the battery pack information.

5. The battery management system according to claim 1, wherein the server is operable to transmit to the user terminal only a portion of the battery unit information received from the information processing unit.

6. The battery management system according to claim 5, wherein, when the server receives a request from the user terminal to transmit contents of the battery unit information that has not been transmitted to the user terminal, the server is operable to transmit the requested contents of the battery unit information to the user terminal.

7. The battery management system according to claim 1, wherein
when the server receives a request from the user terminal to transmit the battery pack information, the server is operable to transmit the request to transmit the battery pack information to the information processing unit;
the information processing unit, having received the request from the server, is operable to transmit the battery pack information to the server; and
the server is operable to transmit to the user terminal the battery pack information received from the information processing unit.
